(19) United States
(12) Patent Application Publication
(10) Pub. No.: US 2014/0246100 A1
(43) Pub. Date: Sep. 4, 2014

(54) WHEELED MATERIAL DISTRIBUTING MACHINERY

(71) Applicants: HUNAN SANY INTELLIGENT CONTROL EQUIPMENT CO., LTD, Changsha (CN); SANY HEAVY INDUSTRY CO., LTD, Changsha (CN)

(72) Inventors: Xin Xu, Changsha (CN); Haiyun Jia, Changsha (CN)

(73) Assignees: HUNAN SANY INTELLIGENT CONTROL EQUIPMENT CO., LTD, Changsha (CN); SANY HEAVY INDUSTRY CO., LTD, Changsha (CN)

(21) Appl. No.: 14/274,060

(22) Filed: May 9, 2014

Related U.S. Application Data
(63) Continuation of application No. PCT/CN2012/073848, filed on Apr. 11, 2012.

(30) Foreign Application Priority Data
Nov. 18, 2011 (CN) 2011103699866

(51) Int. Cl. E04G 21/04; B60P 3/22; B60S 9/02

(52) U.S. Cl. CPC E04G 21/0436; E04G 21/0445; B60S 9/02; B60P 3/2245
USPC 137/351; 198/313

(57) ABSTRACT

In one aspect of the present disclosure, a wheeled material distributing machinery includes a main travel system, a boom system, at least three outrigger mechanisms, and a material distributing frame, where an inner end of a root end boom of the boom system is connected to the material distributing frame, and an inner end of the outrigger mechanism is connected to the material distributing frame, the main travel system is mounted on a cantilever of at least one of the outrigger mechanisms, and the outrigger mechanism is a driving outrigger mechanism. In a travel state, the driving outrigger mechanism is supported on a road surface through the main travel system, and at least a part of the weight of the folded boom system acts on at least one driving outrigger mechanism.

### CROSS-REFERENCE TO RELATED APPLICATIONS

This application is a continuation application of International Patent Application No. PCT/CN2012/073848, filed Apr. 11, 2012, entitled “WHEELED MATERIAL DISTRIBUTION MACHINERY”, by Xin Xu et al., which itself claims the priority to Chinese Patent Application No. 201110369986.6, filed Nov. 18, 2011, entitled “WHEELED MATERIAL DISTRIBUTION MACHINERY”, by Xin Xu et al., the disclosures of which are hereby incorporated herein in their entireties by reference.

### FIELD OF THE INVENTION

The present disclosure relates generally to the field of machinery, and more particularly to a wheeled material distributing machinery.

### BACKGROUND OF THE INVENTION

Pump trucks have become extensively used wheeled material distributing machinery due to convenient use and multiple functions. FIG. 1 is an overall schematic structural diagram of a pump truck in the prior art, and shows a structure of the pump truck in a predetermined working state. Referring to FIG. 1, the pump truck generally includes a travel system 100, a pumping system 300′, and a boom system 200. The travel system 100 is a chassis, and the chassis includes a vehicle frame and multiple axle assemblies mounted on the vehicle frame. The chassis can ensure traveling safety of the pump truck, and meet a transition need of the pump truck. The pumping system 300′ and the boom system 200 are both mounted on the chassis. The pumping system 300′ includes a drive cylinder, a delivery cylinder, a reversing valve, and a hopper, and can pump out the materials under a certain pressure. The boom system 200 includes multiple booms and a delivery pipe. The multiple booms include a root end boom, a terminal end boom, and other booms provided between the two booms, where the booms are sequentially hinge-connected through a horizontal hinge-connecting shaft. An inner end of the root end boom is connected to a bottom frame of the chassis through a slewing mechanism. An inner end of the delivery pipe is in communication with a pumping port of the pumping system 300′, and an outer end thereof extends to an outer end of the terminal end boom along the boom.

The pump truck is generally provided with an outrigger mechanism connected to the chassis. The outrigger mechanism includes a cantilever that basically extends in a horizontal direction and a support boom capable of basically extending in a vertical direction, and the cantilever and the support boom can also perform stretching and retraction, so as to implement a conversion between a support state and a non-support state.

The pump truck has two states: a travel state and a working state. In the travel state, the pumping system 300′ stops pumping the materials, the boom system 200 is folded above the chassis, the support booms of the outrigger mechanism refract, the outrigger mechanism is separated from the ground, and the travel system 100 is supported on the ground. At this time, a transition operation can be implemented by using the travel system 100 (the chassis), so that the pump truck moves from one construction site to another construction site. In a predetermined working state, the chassis is placed horizontally, the support booms of the outrigger mechanism stretch out, and the outrigger mechanism is supported on the ground, so that wheels of the travel system 100 leaves the ground. The outrigger mechanism can provide the pump truck with a large support span, so as to improve the working stability of the pump truck. The boom system 200 is unfolded, the root end boom is connected to the chassis, and the outer end of the terminal end boom stretches outward. The pumping system 300′ delivers concrete or other materials to the outer end of the terminal end boom through the pumping port and the delivery pipe. By changing an included angle between the adjacent booms, the position of the outer end of the terminal end boom can be changed, so that the materials are delivered to a predetermined position and then are distributed within a predetermined range.

As shown in FIG. 1, when the pump truck performs material distributing in the predetermined working state, the chassis is placed horizontally, resulting in that a corresponding space in the construction site is occupied. In the case that requirements on the current construction increasingly grow and the construction site is increasingly crowded, the area occupied by the pump truck is broadened in the case that the chassis occupies the space, thereby reducing the adaptability of the pump truck. In many situations, as the construction site cannot accommodate the chassis, the construction manner has to be changed, and even machinery of another type is used to implement a predetermined construction operation. Not only does the pump truck have such a problem, but also a wheeled material distributing frame having a travel system or other wheeled material distributing machinery also has the same problem. Therefore, how to improve the adaptability of the wheeled material distributing machinery is a technical problem to be solved by persons skilled in the art.

In addition, for the pump truck, as the pumping system 300′ and the boom system 200 are both mounted on the chassis, corresponding requirements need to be made on the pumping system 300′ and the boom system 200 in consideration of a bearing capability and travel safety of the chassis, which restricts the weight and overall dimensions of the pumping system 300′ and the boom system. As a result, a pumping capability of the pumping system 300′ and a material distributing radius of the boom system 200 are all restricted. Currently, with the development of the construction level, the pump truck is required to have a higher pumping capability and a greater material distributing radius. Therefore, it is hard for the existing pump truck to meet the needs in the current construction. For the material distributing frame having a travel system, the chassis also brings restrictions to the weight and the overall dimensions of the boom system. Therefore, how to enhance the pumping capability and/or the material distributing radius of the wheeled material distributing machinery is also a technical problem to be solved by persons skilled in the art.

Therefore, a heretofore unaddressed need exists in the art to address the aforementioned deficiencies and inadequacies.

### SUMMARY OF THE INVENTION

In view of this, one objective of the present disclosure is to provide a wheeled material distributing machinery with higher adaptability. The wheeled material distributing machinery may be a pump truck or a material distributing frame, which can not only perform a transition operation, but also can perform a material distributing operation.

Another objective of the present disclosure is to provide a wheeled material distributing machinery free from restriction of a chassis, thereby laying the basis for the improvement of a material distributing radius and/or a pumping capability.

In one aspect of the present disclosure, a wheeled material distributing machinery includes a main travel system, a boom system, and at least three outrigger mechanisms, and further includes a material distributing frame, where an inner end of a root end boom of the boom system is connected to the material distributing frame, and an inner end of the outrigger mechanisms is connected to the material distributing frame.

The main travel system is mounted on a cantilever of at least one of the outrigger mechanisms, and the outrigger mechanism is a driving outrigger mechanism.

In a travel state, the driving outrigger mechanism is supported on a road surface through the main travel system, and at least a part of the weight of the folded boom system acts on at least one driving outrigger mechanism.

In one embodiment, the main travel system is mounted on the cantilever of the driving outrigger mechanism through a removable mechanism.

In one embodiment, the main travel system includes a vehicle frame and multiple axle assemblies mounted on the vehicle frame, and the vehicle frame is mounted on a cantilever of at least one of the outrigger mechanisms.

In one embodiment, the vehicle frame is mounted on a cantilever of one of the outrigger mechanisms; in the travel state, another outrigger mechanism is supported on the vehicle frame, and the outrigger mechanism is connected to the material distributing frame through a vertical hinge-connecting shaft.

In one embodiment, the main travel system includes multiple axle assemblies, at least one of the multiple axle assemblies is an axle assembly capable of steering, and the axle assembly is mounted on the cantilever of the driving outrigger mechanism.

In one embodiment, at least one of the axle assemblies is an axle assembly having an independent drive mechanism.

In one embodiment, at least two driving outrigger mechanisms are formed. The multiple axle assemblies are at least divided into a first axle assembly group and a second axle assembly group, where the axle assembly of the first axle assembly group is mounted on the cantilever of a driving outrigger mechanism, and the axle assembly of the second axle assembly group is mounted on the cantilever of another driving outrigger mechanism.

In one embodiment, extension directions of the driving outrigger mechanisms remain parallel with each other.

In one embodiment, an inner end of each of the outrigger mechanisms is hinge-connected to the material distributing frame through a vertical hinge-connecting shaft, and the axle assembly is connected to the cantilever of the driving outrigger mechanism through a vertical hinge-connecting shaft.

In one embodiment, the material distributing frame includes a slewing mechanism, where the slewing mechanism includes a rotary component and a fixed component that form a rotatable fit, the rotary component is connected to the inner end of the root end boom, and the inner end of the outrigger mechanism is connected to the fixed component.

In one embodiment, the material distributing frame is hinge-connected to the inner end of the root end boom through a horizontal hinge-connecting shaft.

In one embodiment, the material distributing frame is fixedly connected to the inner end of the root end boom, and the driving outrigger mechanism is connected to the material distributing frame through a horizontal hinge-connecting shaft.

In one embodiment, the wheeled material distributing machinery further includes a pumping assembly connected to the material distributing frame, where the pumping assembly includes a pumping system and a pump auxiliary travel system connected to the pumping system.

In one embodiment, a pumping support of the pump auxiliary travel system is connected to the material distributing frame through a middle hinge-connecting shaft, and the axis of the middle hinge-connecting shaft is perpendicular to a horizontal plane.

In one embodiment, the wheeled material distributing machinery further includes an outrigger mechanism having an inner end hinge-connected to the pumping support through an outrigger hinge-connecting shaft, where the axis of the outrigger hinge-connecting shaft is parallel with the axis of the middle hinge-connecting shaft.

In one embodiment, the wheeled material distributing machinery further includes a frame auxiliary travel system, where an axle assembly of the frame auxiliary travel system is mounted on the material distributing frame, and in the travel state, the axle assembly of the frame auxiliary travel system is supported on the road surface.

In one embodiment, the wheeled material distributing machinery further includes a turning drive mechanism connected to the boom system, where when the wheeled material distributing machinery switches from the travel state to the predetermined working state, the turning drive mechanism is supported on the ground, and drives the boom system to turn.

In one embodiment, the wheeled material distributing machinery further includes an operating cab located on the outrigger mechanism or a predetermined boom of the boom system, where the operating cab includes a travel control mechanism, and the travel control mechanism is capable of controlling operation of the main travel system.

In one embodiment, the wheeled material distributing machinery further includes a state detection sensor and a controller, where the state detection sensor is used to detect a state of the root end boom, and the controller outputs a position signal according to a detection signal of the state detection sensor.

In one embodiment, the state detection sensor is a tilt-angle sensor, the tilt-angle sensor detects a tilt angle of the root end boom, and the controller determines, according to a detection result of the tilt-angle sensor, whether state switching is completed, and when it is determined that the state switching is completed, outputs a predetermined position signal.

The wheeled material distributing machinery according to the present disclosure includes a main travel system for implementing a transition operation, a boom system for implementing a material distributing operation, and an outrigger mechanism for ensuring working stability of the wheeled material distributing machinery. The wheeled material distributing machinery further includes a material distributing frame. An inner end of a root end boom of the boom system is connected to the material distributing frame, and an inner end of the outrigger mechanism is connected to the material distributing frame. The main travel system is mounted on a cantilever of at least one of the outrigger mechanisms, and the outrigger mechanism is a driving outrigger mechanism. In a travel state, the driving outrigger mechanism is supported on a road surface through the main travel system, and at least a part of the weight of the folded boom system acts on one or more driving outrigger mechanisms. In this manner, in the travel state, the outer end of the outrigger mechanism remains separated from the ground, the main travel system is supported on the ground, and a load of the boom system acts on the main travel system through the driving outrigger mechanism; therefore, the transition of the machinery can be easily achieved by using the main travel system, thereby ensuring flexibility of the machinery in the transition operation. During the material distributing operation, according to the actual requirements, the outer end of the outrigger mechanism is supported on a working plane, and the main travel system remains separated from the working plane or does not bear a load; then, the boom system are unfolded, so that the wheeled material distributing machinery switches to a predetermined working state. In the predetermined working state, the outrigger mechanism can provide a predetermined support force, so as to ensure a support span of the wheeled material distributing machinery and improve the stability of the material distributing operation. In this manner, the main travel system is located below the cantilever of outrigger mechanism, a space occupied by the main travel system at least partially overlaps a space occupied by the outrigger mechanism, thereby reducing the area occupied by the wheeled material distributing machinery in the predetermined working state; therefore, the material distributing operation can also be performed in a small-area construction site, thereby improving the adaptability of the wheeled material distributing machinery.

In one embodiment, the main travel system is mounted on the cantilever of the driving outrigger mechanism through a removable mechanism. In this manner, when the wheeled material distributing machinery switches to the working state, the main travel system may be separated from the driving outrigger mechanism, and the main travel system is moved to another suitable position, which can not only further reduce the area occupied by the wheeled material distributing machinery, but also facilitate the operation of the wheeled material distributing machinery.

In one embodiment, the vehicle frame is connected to the outrigger mechanism. In the travel state, another outrigger mechanism is supported on the vehicle frame, and is connected to the material distributing frame through a vertical hinge-connecting shaft. In this manner, when the wheeled material distributing machinery switches from the working state to the travel state, first, the outer ends of the outrigger mechanisms retract and are separated from the ground, then an included angle between another outrigger mechanism and the driving outrigger mechanism is changed by swinging the another outrigger mechanism, the two outrigger mechanisms draw close to each other and are both supported on the vehicle frame, and finally, the folded boom system is supported on the two outrigger mechanisms, thereby not only reducing the horizontal width of the wheeled material distributing machinery in the travel state, but also ensuring the stability of the folded boom system and facilitating the transition operation of the wheeled material distributing machinery.

In one embodiment, the main travel system includes multiple axle assemblies, which are mounted on a cantilever of the driving outrigger mechanism. At least one of the multiple axle assemblies is a steering axle assembly. In the travel state, the multiple axle assemblies are connected through the driving outrigger mechanism, and the driving outrigger mechanism assumes the function of the vehicle frame of the main travel system. The steering axle assembly can implement steering of the main travel system, so as to facilitate the transition of the wheeled material distributing machinery. In the predetermined state, the driving outrigger mechanism assumes the support function of the outrigger mechanism in the prior art. In the prior art, the vehicle frame of the main travel system can implement the corresponding functions only in the travel state, and the outrigger mechanism can implement the support function only in the predetermined working state. In the wheeled material distributing machinery according to the present disclosure, the driving outrigger mechanism can implement different functions in two states and have two functions; therefore, this solution can make better use of the driving outrigger mechanism. As the vehicle frame of the main travel system can be saved, on the premise that the material distributing capability is remain unchanged, the weight and manufacturing cost of the wheeled material distributing machinery can be lowered, the energy consumption in the transition process can be reduced, and the use cost can be decreased. Importantly, the wheeled material distributing machinery obtained by using this technical solution can serve as, by reducing the design speed per hour, a wheeled special-purpose machinery vehicle defined in Technical Conditions for the Safe Operation of Motor Vehicles. On the premise that the operation safety is ensured, the wheeled special-purpose machinery vehicle can have larger overall dimensions, which breaks restrictions of the chassis on the material distributing radius of an existing pump truck such as the wheeled material distributing machinery in the prior art; therefore, the boom system can have larger size, the material distributing radius can be increased, and the material distributing capability can be improved. In the case that the wheeled material distributing machinery includes the pumping system, the pumping system can have larger size by using this technical solution, thereby laying the basis for the improvement of the pumping capability. Therefore, this technical solution can lay the basis for the improvement of the pumping capability and the material distributing radius.

In one embodiment, the main travel system is connected to the at least two outrigger mechanisms, to form at least two driving outrigger mechanisms. The multiple axle assemblies are at least divided into a first axle assembly group and a second axle assembly group, where the axle assembly of the first axle assembly group is mounted on a cantilever of the driving outrigger mechanism, and the axle assembly of the second axle assembly group is mounted on the cantilever of another driving outrigger mechanism. In this technical solution, in the travel state, two outrigger mechanisms are used to assume the travel function, thereby improving the travel stability of the wheeled material distributing machinery.

In one embodiment, extension directions of the driving outrigger mechanisms remain parallel with each other, thereby facilitating control on the transition operation of the wheeled material distributing machinery and improving flexibility of the transition operation.

In one embodiment, inner ends of the outrigger mechanisms (including the driving outrigger mechanisms) are hinge-connected to the material distributing frame through a vertical hinge-connecting shaft. In the working state, an included angle between two driving outrigger mechanisms can be changed through swinging, so as to provide a more reliable support function in the material distributing operation of the wheeled material distributing machinery. Meanwhile, the axle assemblies are connected to the driving outrigger mechanisms through the vertical hinge-connecting shaft, so as to adjust a relative relationship between the two driving outrigger mechanisms and the axle assemblies, thereby conveniently controlling the travel direction of the wheeled material distributing machinery in the travel state.

In one embodiment, the material distributing frame is hinge-connected to the inner end of the root end boom through a vertical hinge-connecting shaft; in this manner, the relationship between the material distributing frame and the root end boom can be conveniently adjusted, and the state of the material distributing frame can be conveniently adjusted in the working state and/or the travel state.

In one embodiment, the material distributing frame is fixedly connected to the inner end of the root end boom, thereby ensuring reliable connection between the boom system and the material distributing frame, and improving the overall rigidity of the wheeled material distributing machinery. Meanwhile, the driving outrigger mechanism is connected to the material distributing frame through a horizontal hinge-connecting shaft; then, during state switching, the material distributing frame and the boom system are turned as a whole, which facilitates the state switching of the wheeled material distributing machinery.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is an overall schematic structural diagram of a pump truck in the prior art, and shows a structure of the pump truck in a predetermined working state.

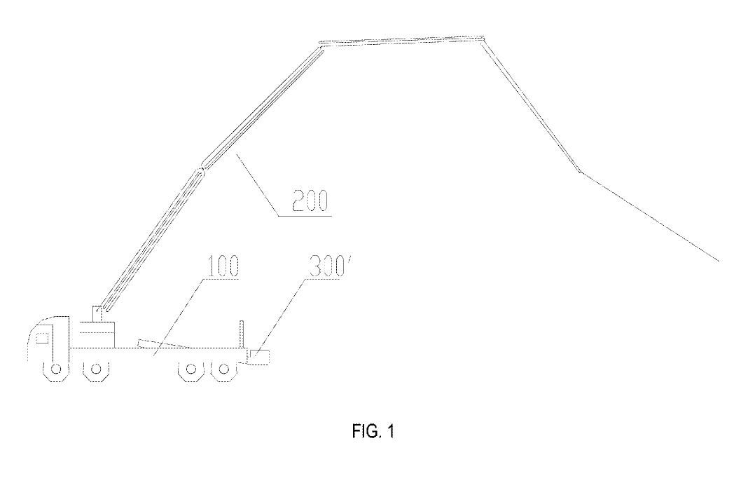

FIG. 2 is a schematic structural diagram of a wheeled material distributing machinery according to a first embodiment of the present disclosure, and shows a structure of the wheeled material distributing machinery in a travel state.

FIG. 3 is a schematic structural diagram showing a stretching state of an outrigger mechanism when the wheeled material distributing machinery provided in the first embodiment of the present disclosure switches from the travel state to a predetermined working state.

FIG. 4 is a schematic structural diagram of the wheeled material distributing machinery in the predetermined working state according to the first embodiment of the present disclosure.

FIG. 5 shows a wheeled material distributing machinery according to a second embodiment of the present disclosure, and is a schematic structural diagram of the wheeled material distributing machinery in a travel state.

### DETAILED DESCRIPTION OF THE INVENTION

The present disclosure will now be described more fully hereinafter with reference to the accompanying drawings, in which exemplary embodiments of the disclosure are shown.

This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “with” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as with a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The description will be made as to the embodiments of the present disclosure in conjunction with the accompanying drawings. In accordance with the purposes of this disclosure, as embodied and broadly described herein, this disclosure, in one aspect, relates to a wheeled material distributing machinery.

In this application, the horizontal direction and the vertical direction are determined with reference to the horizontal plane, where the horizontal direction is a direction basically parallel with the horizontal plane, and the vertical direction is a direction basically perpendicular to the horizontal plane.

An axle assembly described in this application includes an axle and a wheel, where the axle may be mounted on a corresponding mechanism in an existing manner. A specific form of the axle may adopt an existing specific structure according to the actual requirements, for example, may adopt a steering axle, a drive axle, a steering and drive axle, and a support axle; and may also form an axle having an independent drive mechanism. The axle assembly may include merely one wheel, or two or four wheels. The wheel may be mounted in an existing manner, so as to implement a predetermined function and meet the actual requirements.

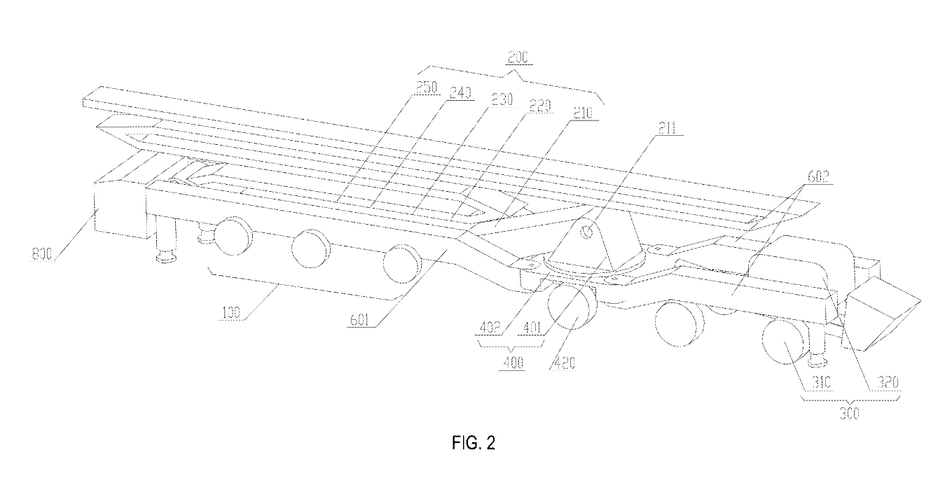

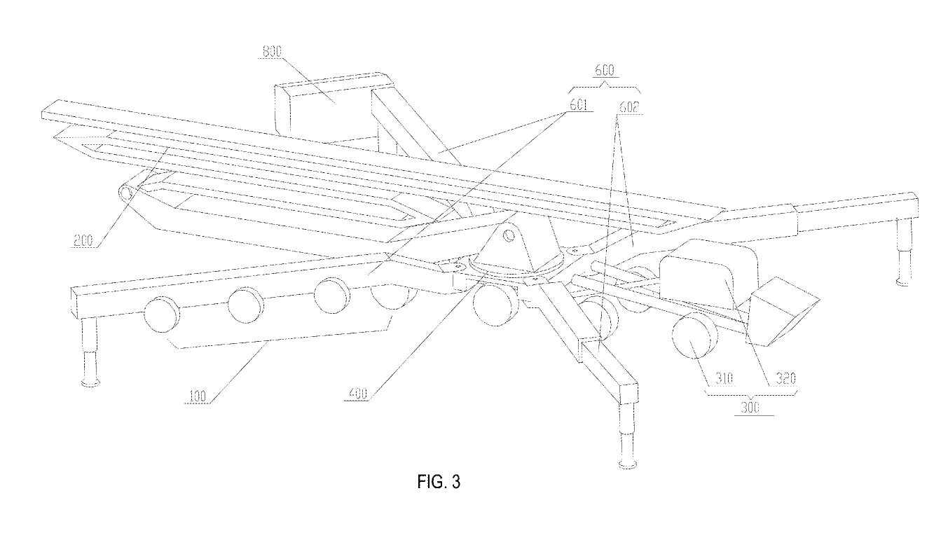

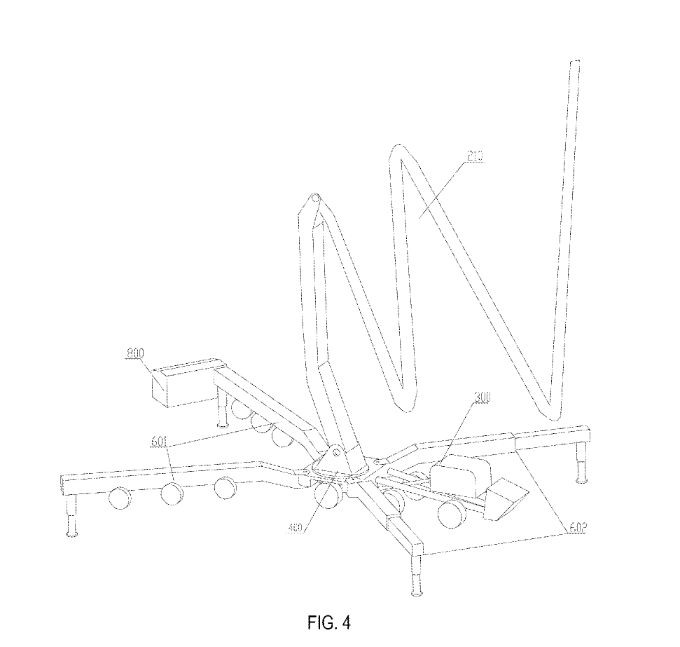

Referring to FIG. 2 to FIG. 4, FIG. 2 is a schematic structural diagram of a wheeled material distributing machinery provided in a first embodiment of the present disclosure, and shows a structure of the wheeled material distributing machinery in a travel state; while FIG. 3 is a schematic structural diagram showing a stretching state of an outrigger mechanism when the wheeled material distributing machinery provided in the first embodiment of the present disclosure switches from the travel state to a predetermined working state; and FIG. 4 is a schematic structural diagram of the wheeled material distributing machinery in the predetermined working state provided in the first embodiment of the present disclosure.

The wheeled material distributing machinery includes a main travel system 100, a boom system 200, and a pumping assembly 300; the wheeled material distributing machinery can perform material distributing and material pumping. In this embodiment, the boom system 200 includes five booms that are sequentially hinge-connected through a horizontal hinge-connecting shaft, and the five booms are respectively a root end boom 210, a second boom 220, a third boom 230, a fourth boom 240 and a fifth boom 250. A pumping system 320 of the pumping assembly 300 may be the same as an existing pumping system, and may include components such as a hopper, a delivery cylinder, and hydraulic oil. The pumping system 320 may be disposed with an independent dynamical system, so as to independently drive the pumping system 320 to operate. The wheeled material distributing machinery further includes a material distributing frame 400, the material distributing frame 400 includes a slewing mechanism, the slewing mechanism includes a rotary component 401 and a fixed component 402 that form a rotatable fit, and the rotatable fit forms a slewing central line of the slewing mechanism. As shown in FIG. 2, in this embodiment, in the travel state, the slewing central line of the slewing mechanism is perpendicular to the horizontal plane.

The wheeled material distributing machinery further includes four outrigger mechanisms 600. The outrigger mechanism 600 may adopt the prior art, and may use one or a combination of a retractable manner, a vertical hinge-connecting manner, and a horizontal hinge-connecting manner. An inner end of the outrigger mechanism 600 is connected to the material distributing frame 400, and in this embodiment, an inner end of a cantilever of each outrigger mechanism 600 is hinge-connected to the fixed component 402 of the material distributing frame 400 through a vertical hinge-connecting shaft. In this manner, each outrigger mechanism 600 can swing around the slewing central line of the slewing mechanism and with respect to the material distributing frame 400. In this embodiment, in the travel state, the cantilevers of two outrigger mechanisms 600 extending forward are of a fixed structure, the cantilevers of two outrigger mechanisms 600 extending backward each include two sections, to form a retractable structure.

The main travel system 100 includes multiple axle assemblies. The multiple axle assemblies are directly mounted on the two outrigger mechanisms 600 extending forward. In order to show the difference, the two outrigger mechanisms 600 mounted with the axle assemblies are referred to as driving outrigger mechanisms, and are marked as 601. In this embodiment, the multiple axle assemblies of the main travel system 100 are divided into two groups, to form a first axle assembly group and a second axle assembly group, where the axle assembly of the first axle assembly group is mounted on the cantilever of one driving outrigger mechanism 601, and the axle assembly of the second axle assembly group is mounted on the cantilever of the other driving outrigger mechanism 601. The multiple axle assemblies may be disposed in an axle layout manner of the existing chassis, and may also be disposed according to a load distribution of the wheeled material distributing mechanism. The axle assembly located in the front portion may be set to be an axle assembly capable of steering. It can be understood that, as long as at least one axle assembly is an axle assembly capable of steering, a steering operation of the main travel system 100 can be implemented by appropriately arranging the layout of the axle assemblies, thereby ensuring or improving the flexibility of the main travel system 100.

An inner end of the root end boom 210 of the boom system 200 is connected to the rotary component 401 of the material distributing frame 400. In this manner, the boom system 200 can rotate with respect to the outrigger mechanism 600 and around the slewing central line of the slewing mechanism. The slewing mechanism may be disposed with an existing drive mechanism, so as to drive the rotary component 401 to rotate with respect to the fixed component 402, and change a position of the boom system 200. In this embodiment, the inner end of the root end boom 210 is hinge-connected to the rotary component 401 of the slewing mechanism through a root end hinge-connecting shaft 211, to form a hinge-connecting structure. Corresponding to the hinge-connecting structure, a turning hydraulic cylinder may be further disposed as a boom drive mechanism, and two ends of the turning hydraulic cylinder are hinge-connected to the root end boom 210 and the rotary component 401 respectively. When the turning hydraulic cylinder stretches or retracts, the root end boom 210 can rotate with respect to the rotary component 401 and around the axis of the root end hinge-connecting shaft 211, so as to change a relative position between the root end boom 210 and the material distributing frame 400. For ease of transition of the pumping system 320, in this embodiment, the pumping assembly 300 is further disposed with a pump auxiliary travel system 310, and the pump auxiliary travel system 310 is connected to the pumping system 320. The pump auxiliary travel system 310 is also formed by multiple axle assemblies, and each axle assembly may be mounted on a delivery cylinder of the pumping system 320. In the travel state, the pumping system 320 is connected to the material distributing frame 400 in a towing manner, the pump auxiliary travel system 310 is supported on a road surface, and the weight of the pumping system 320 acts on the pump auxiliary travel system 310. To reasonably distribute the load of the wheeled material distributing machinery and ensure the stability of the travel state, in the first embodiment, a frame auxiliary travel system 420 is further provided. The axle assemblies of the frame auxiliary travel system 420 are mounted on the material distributing frame 400. In the travel state, the weight of the material distributing frame 400 basically acts on the frame auxiliary travel system 420.

As shown in FIG. 2, in the travel state, support booms of the outrigger mechanisms 600 retract, and are separated from the ground. The two driving outrigger mechanisms 601 draw close to each other, remain parallel with each other in the extension directions, and are supported on the road surface through the main travel system 100. The folded boom system 200 is located above the two driving outrigger mechanisms 601, the formed load of the boom system 200 acts on the driving outrigger mechanisms 601, and then the weight thereof acts on the two driving outrigger mechanisms 601. The other two outrigger mechanisms 602 extend backward and draw close to each other, also remain parallel with each other in the extension directions, are supported on two sides of the pump auxiliary travel system 310 of the pumping assembly 300 respectively, and are separated from the road surface.

In this manner, in the travel state, the outrigger mechanisms 600 remain separated from the ground, and contact the ground through the main travel system 100, the pump auxiliary travel system 310, and the frame auxiliary travel system 420, thereby easily implementing the transition operation of the wheeled material distributing machinery.

Referring to FIG. 3 and FIG. 4, when the wheeled material distributing machinery switches from the travel state to a predetermined working state, by using the turning hydraulic cylinder, a crane, or another auxiliary machinery, the boom system 200 may be raised and is separated from the driving outrigger mechanism 602. Then, the two driving outrigger mechanisms 601 is swung at an appropriate angle toward two sides, the support booms thereof are stretched and are supported on the ground. Meanwhile, the cantilevers of the two outrigger mechanisms 602 are stretched, and then the support booms thereof are stretched and are supported on the ground, so that the outrigger mechanism 600 is supported on the ground. Subsequently, by using the turning hydraulic cylinder, the crane, or another auxiliary machinery, the boom system 200 may turn at an appropriate angle with respect to the material distributing frame 400. Finally, in an existing manner, the boom system 200 may be rotated with respect to the material distributing frame 400 and around the slewing central line of the slewing mechanism; or in an existing manner, the booms of the boom system 200 are stretched, so as to perform the material distributing operation on the basis of the outrigger mechanism 600 and the material distributing frame 400.

In the predetermined working state, the outrigger mechanism 600 can provide a predetermined support force, to ensure a support span of the wheeled material distributing machinery and improve the stability of the material distributing operation. As the main travel system 100 is located below the cantilever of the driving outrigger mechanism 601, the space occupied by the main travel system 100 overlaps the space occupied by the driving outrigger mechanism 601, thereby reducing the area occupied by the wheeled material distributing machinery in the predetermined working state, so that the wheeled material distributing machinery can also perform the material distributing operation in a small-area construction site, thereby improving the adaptability of the wheeled material distributing machinery.

It can be understood that, the material distributing frame 400 may also be fixedly connected to the inner end of the root end boom 210, so as to improve the overall rigidity of the wheeled material distributing machinery. At this time, the driving outrigger mechanism 601 may be connected to the material distributing frame 400 through a vertical hinge-connecting shaft (to implement the support function of the outrigger mechanism, the material distributing frame 400 needs to be disposed with a stopping structure according to the prior art, so that the inner end of the outrigger mechanism is clamped at an appropriate position of the material distributing frame 400). In this manner, when the driving outrigger mechanism 601 is supported on the ground, the material distributing frame 400 may be rotated around the horizontal hinge-connecting shaft and with respect to the driving outrigger mechanism 601; in this manner, the boom system 200 and the material distributing frame 400 turn at the same time when the boom system 200 turns. Therefore, in the travel state, the relationship between the slewing central line of the slewing mechanism of the material distributing frame 400 and the horizontal plane is not limited to a vertical manner, and a predetermined acute angle may be formed between the slewing central line and the horizontal plane; or the slewing central line may be parallel with the horizontal plane; or the relationship therebetween may be determined according to actual requirements.

In the travel state, the multiple axle assemblies of the main travel system 100 contact the road surface, and are supported on the road surface. The main travel system 100 may perform power distribution in an existing manner and by using an existing dynamical system; or at least one axle assembly has an independent drive mechanism. In addition, the main travel system 100 may also be towed by other dynamical devices or machinery.

In this embodiment, the main travel system 100 includes multiple axle assemblies, which are mounted on the cantilever of the driving outrigger mechanism. At least one of the multiple axle assemblies is a steering axle assembly. In the travel state, the multiple axle assemblies are connected through the driving outrigger mechanism 601, and the driving outrigger mechanism 601 assumes the function of the vehicle frame of the main travel system. The steering axle assembly can implement steering of the main travel system 100, so as to facilitate the transition of the wheeled material distributing machinery. In the predetermined state, the driving outrigger mechanism 601 assumes the support function. In the prior art, the vehicle frame of the main travel system 100 can implement the corresponding functions only in the travel state, and the outrigger mechanisms can implement the corresponding function only in the predetermined working state. In the wheeled material distributing machinery according to the present disclosure, the driving outrigger mechanism 601 of the outrigger mechanism 600 can implement different functions in two states and have two functions; therefore, this solution can make better use of the driving outrigger mechanism 601. As the vehicle frame of the existing chassis can be saved, on the premise that the material distributing capability is remain unchanged, the weight and manufacturing cost of the wheeled material distributing machinery can be lowered, the energy consumption in the transition process can be reduced, and the use cost can be decreased. Importantly, the wheeled material distributing machinery obtained by using this technical solution can serve as, by reducing the design speed per hour, a wheeled special-purpose machinery vehicle defined in Technical Conditions for the Safe Operation of Motor Vehicles. On the premise that the operation safety is ensured, the wheeled special-purpose machinery vehicle can have larger overall dimensions, which breaks restrictions of the chassis in the prior art on the material distributing radius of an existing pump truck such as the wheeled material distributing machinery; therefore, the boom system can have larger size, the material distributing radius can be increased, and the material distributing capability can be improved. In the case that the wheeled material distributing machinery includes the pumping system 320, the pumping system 320 can have larger size by using this technical solution, thereby laying the basis for the improvement of the pumping capability of the pumping system. Therefore, this technical solution can lay the basis for the improvement of the pumping capability and the material distributing radius.

In addition, the main travel system 100 may also adopt the existing chassis stricture. The main travel system 100 may include a vehicle frame and multiple axle assemblies mounted on the vehicle frame, and the vehicle frame is mounted on a cantilever of at least one outrigger mechanism 600 (the outrigger mechanism forms the foregoing driving outrigger mechanism 601). In this manner, in the predetermined working state, the overall chassis may overlap the driving outrigger mechanism 601 to a certain extent, so as to reduce the area occupied by the wheeled material distributing machinery in the predetermined working state, and achieve the objective of the present disclosure.

Furthermore, the main travel system 100 (a chassis or axle assemblies) may be mounted on the cantilever of the driving outrigger mechanism 601 through a removable mechanism. In this manner, when the wheeled material distributing machinery switches to the working state, the main travel system 100 is separated from the driving outrigger mechanism 601, and is moved to another position, thereby not only reducing the space occupied by the main travel system 100, but also facilitating the operation of the wheeled material distributing machinery.

In this embodiment, inner ends of the outrigger mechanisms 600 are all hinge-connected to the material distributing frame 400 through the vertical hinge-connecting shaft. Meanwhile, the axle assembly is hinge-connected to the cantilever of the driving outrigger mechanism 601 through the vertical hinge-connecting shaft. In this manner, an angle between the axle assembly and the driving outrigger mechanism 601 can be adjusted more easily, so that the travel directions of the axle assemblies on the two driving outrigger mechanisms 601 remain parallel with each other, thereby facilitating the transition operation of the wheeled material distributing machinery.

In this embodiment, the pumping system is provided. Therefore, the working state includes a pumping state and a material distributing state. The wheeled material distributing machinery provided in this embodiment is not limited to the foregoing working states, and may perform pumping and material distributing in another working state. For example, when the material distributing scope is small and the boom system 200 does not need to be fully stretched, the wheeled material distributing machinery may perform the construction operation in another working state. At this time, the main travel system 100 may contact the ground (or contact the ground by an appropriate auxiliary outrigger mechanism), the second boom 220, the third boom 230, the fourth boom 240, and the fifth boom 250 are merely stretched, and the material distributing can be performed within a predetermined range by changing the positions of the second boom 220, the third boom 230, the fourth boom 240, and the fifth boom 250.

According to the foregoing description, the material distributing frame 400 is not limited to including the slewing mechanism. In the case that the root end boom 210 is ensured to be connected to the material distributing frame 400, the objective of the present disclosure may also be achieved. In addition, in order that the travel directions of the axle assemblies on the two driving outrigger mechanisms 601 remain parallel with each other, the extension directions of the driving outrigger mechanisms 601 remain parallel with each other. At this time, the inner ends of the driving outrigger mechanisms 601 may be fixedly connected to the material distributing frame 400, and may also be connected to the material distributing frame 400 in another manner.

According to the actual requirements, the layout of the relevant components may be correspondingly performed. For example, the pumping system 320 may also be connected to the material distributing frame 400 or the boom system 200 in another existing manner. In the travel state, at least a part of the weight of the pumping system 320 is enabled to act on the driving outrigger mechanism 601, so the pump auxiliary travel system 310 is saved. The outrigger mechanism 600 is not limited to the foregoing layout, and on the premise that at least three outrigger mechanisms 600 are reserved, the outrigger mechanism 600 extending backward may be saved. The main travel system 100 is not limited to be mounted on the two outrigger mechanisms 600, and may also be mounted on at least one outrigger mechanism 600, to form at least one driving outrigger mechanism 601, thereby achieving the objective of the present disclosure. For example, the vehicle frame may be mounted on the cantilever of the first outrigger mechanism 600. At this time, the second outrigger mechanism 600 may be connected to the material distributing frame 400 through the vertical hinge-connecting shaft. In the working state, the second outrigger mechanism 600 may be swung at an appropriate angle, around the vertical hinge-connecting shaft, and with respect to the first outrigger mechanism. When the working state is switched to the travel state, the second outrigger mechanism 600 may be swung at an appropriate angle toward the first outrigger mechanism 600, and draw close to the first outrigger mechanism 600, so that the second outrigger mechanism 600 is supported on the vehicle frame. Therefore, in the travel state, the boom system 200 may be supported above the cantilevers of the two outrigger mechanisms 600, so as to ensure the stability of the folded boom system 200. In addition, in the travel state, the folded boom system 200 is not limited to be supported on the two driving outrigger mechanisms 601. As long as at least a part of the weight of the folded boom system 200 acts on at least one driving outrigger mechanism 601, the objective of the present disclosure can be achieved (definitely, according to the actual requirements, the frame auxiliary travel system 420 may be used to bear a part of weight of the boom system 200).

For ease of state switching of the wheeled material distributing machinery, the wheeled material distributing machinery may be further disposed with a detection system, and the detection system may include a state detection sensor and a controller. The state detection sensor is used to detect the state of the root end boom 210, and the controller outputs a position signal according to the detection signal of the state detection sensor; then, the operator can determine the state of the root end boom 210 according to the position signal output by the controller. The state detection sensor may directly detect height of center of gravity of the root end boom 210, may determine the state of the root end boom 210 by detecting whether the main travel system 100 contacts the working plane (the road surface), and may also determine the state of the root end boom 210 by detecting a position relationship between the root end boom 210 and the material distributing frame 400. In this embodiment, the state detection sensor is a tilt-angle sensor, and the tilt-angle sensor detects a tilt angle of the root end boom 210. The controller determines, according to a detection result of the tilt-angle sensor, whether the root end boom 210 is perpendicular to or parallel with the working plane, so as to determine whether the state switching is completed. After determining that the state switching is completed, the controller sends a predetermined position signal. When the wheeled material distributing machinery switches from the corresponding working state to the travel state, the controller sends a position signal; and when the wheeled material distributing machinery switches from the travel state to the corresponding working state, the controller sends another position signal; then, an operator can determine whether the state switching is completed according to different position signals.

To ensure the working stability of the wheeled material distributing machinery, a balancing weight disposed in a relevant part is further included. For example, a balancing weight connected to the material distributing frame and/or the outrigger mechanism may be disposed, so as to balance the stress applied on the whole machinery.

Referring to FIG. 2 to FIG. 4, the wheeled material distributing machinery provided by the first embodiment of the present disclosure further includes an operating cab 800 located at an outer end of the root end boom 210 of the boom system 200. The operating cab 800 may include a travel control mechanism and a pumping control mechanism inside. The travel control mechanism can be used to control the operation of the main travel system 100, and the pumping control mechanism can be used to control the operation of the pumping system 320. In this manner, in the travel state, the operator can control the operation of the main travel system 100 in the operating cab 800, thereby facilitating the transition of the wheeled material distributing machinery. In a corresponding working state, the operator can control the operation of the pumping system 320 in the operating cab 800. Definitely, the operating cab 800 may also be provided on the root end boom 210 of the boom system 200 or on another boom of the boom system 200.

To bring convenience to the wheeled material distributing machinery and reduce the dependence on another auxiliary machinery device, a turning drive mechanism may be further independently disposed. For example, the wheeled material distributing machinery may further include a turning cylinder having one end connected to a corresponding boom of the boom system 200. When the wheeled material distributing machinery switches from the travel state to the corresponding working state, another end of the turning cylinder is supported on the ground, and the turning cylinder is elongated, thereby driving the boom system 200 to turn. In the travel state, when the slewing central line of the material distributing frame is not perpendicular to the horizontal plane, the turning cylinder may also be connected to the material distributing frame 400, and then is connected to the boom system 200 through the material distributing frame 400. when the wheeled material distributing machinery switches from the travel state to the corresponding working state, one end of the turning cylinder is supported on the ground, and then the turning cylinder is elongated, so as to drive the material distributing frame 400 to turn, or to drive the boom system 200 and the material distributing frame 400 to turn together. Definitely, the turning drive mechanism is not limited to be implemented by using the turning cylinder, and may also be implemented by using another existing mechanism, such as a lever mechanism, a pulley mechanism, and the like.

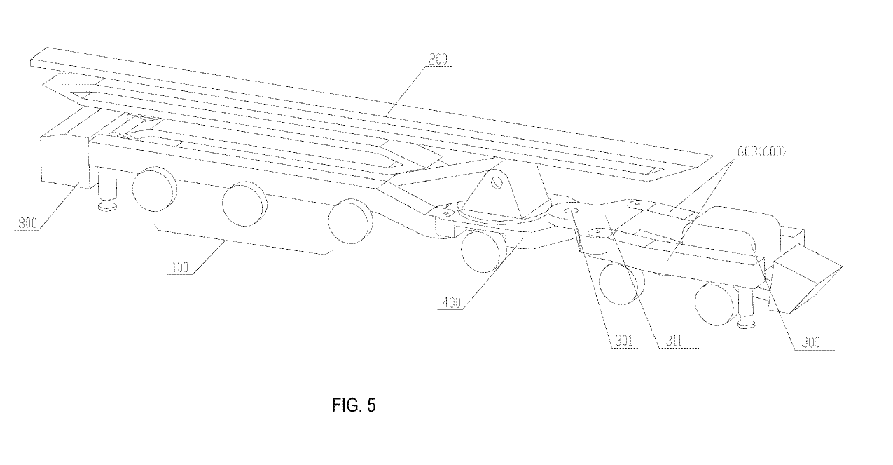

To ensure the relative position between the pumping assembly 300 and the material distributing frame 400, and facilitate the connection between the pumping port of the pumping system 320 and the delivery pipe of the boom system 200, an appropriate connection mechanism may be further formed between the pumping assembly 300 and the material distributing frame 400. FIG. 5 shows a wheeled material distributing machinery provided by a second embodiment of the present disclosure, and is a schematic structural diagram of the wheeled material distributing machinery in a travel state.

In comparison with the wheeled material distributing machinery provided by the first embodiment, in the wheeled material distributing machinery provided by the second embodiment, the pump auxiliary travel system 310 includes a pumping support 311 and an axle assembly connected to the pumping support 311. The pumping support 311 is hinge-connected to the material distributing frame 400 through a middle hinge-connecting shaft 301, and the middle hinge-connecting shaft 301 is perpendicular to the horizontal plane (when the material distributing frame 400 includes a slewing mechanism, the pumping frame 311 is specifically connected to the fixed component 402). In this manner, the relative position between the pumping system 320 and the material distributing frame 400 may be determined through the middle hinge-connecting shaft 301, thereby facilitating the connection between the pumping port of the pumping system 320 and the delivery pipe of the boom system 200, and improving the material delivery stability. It can be understood that, at this time, the weight of the pumping system 320 is partially transferred to the material distributing frame 400 through hinge-connection, which facilitates rational distribution of the load of the wheeled material distributing machinery. Definitely, in another case, the weight of the pumping system 320 is partially transferred to other parts through the corresponding structure.

To ensure the working stability of the pumping system 320, in this embodiment, an outrigger mechanism 600 (in order to show the difference, the outrigger mechanism 600 is marked as 603) hinge-connected to the pumping frame 311 is further disposed. An inner end of the outrigger mechanism 603 is hinge-connected to the pumping frame 311 through an outrigger hinge-connecting shaft, and the axis of the outrigger hinge-connecting shaft is parallel with the axis of the middle hinge-connecting shaft 301. In a corresponding working state, an outer end of the outrigger mechanism 603 is supported on the working plane, which provides a support force for the pumping frame 311, thereby improving the stability of the pumping system 320.

The technical contents included in the foregoing technical solution may be integrated according to the actual requirements, so as to form the corresponding technical solution, solve the corresponding technical problem encountered in the actual conditions, and meet the actual requirements.

The technical solutions according to the present disclosure are illustrated through specific embodiments, and the embodiments above are described merely for ease of understanding of the technical solutions according to the present disclosure. It should be noted that, persons with ordinary skill in the art may further made several improvements and modifications to the present disclosure without departing from the principle of the present disclosure. For example, as the material distributing frame 400 bears a lot, an outrigger mechanism 600 having an inner end connected to the material distributing frame 400 may be disposed according to the actual requirements; the operating cab 800 is not limited to be disposed on the outrigger mechanism 600 extending upward, and may be disposed on an outer end of the corresponding outrigger mechanism 600 or on another part of the outrigger mechanism 600 according to the actual control requirements. The improvements and modifications all fall within the protection scope of claims of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. Wheeled material distributing machinery, comprising:
a main travel system (100);
a boom system (200);
at least three outrigger mechanisms (600); and
a material distributing frame (400),
wherein an inner end of a root end boom (210) of the boom system (200) is connected to the material distributing frame (400), and an inner end of the outrigger mechanism (600) is connected to the material distributing frame (400);
the main travel system (100) is mounted on a cantilever of at least one of the outrigger mechanisms (600), and the outrigger mechanism is a driving outrigger mechanism (601); and
in a travel state, the driving outrigger mechanism (601) is supported on a road surface through the main travel system (100), and at least a part of the weight of the folded boom system (200) acts on at least one driving outrigger mechanism (601).

2. The wheeled material distributing machinery according to claim 1, wherein the main travel system (100) is mounted on the cantilever of the driving outrigger mechanism (601) through a removable mechanism.

3. The wheeled material distributing machinery according to claim 1, wherein the main travel system (100) comprises a vehicle frame and multiple axle assemblies mounted on the vehicle frame, and the vehicle frame is mounted on a cantilever of at least one of the outrigger mechanisms (600).

4. The wheeled material distributing machinery according to claim 3, wherein the vehicle frame is mounted on a cantilever of one of the outrigger mechanisms (600), and in the travel state, another outrigger mechanism (600) is supported on the vehicle frame, and the outrigger mechanism (600) is connected to the material distributing frame (400) through a vertical hinge-connecting shaft.

5. The wheeled material distributing machinery according to claim 1, wherein the main travel system (100) comprises multiple axle assemblies, at least one of the multiple axle assemblies is an axle assembly capable of steering, and the axle assembly is mounted on the cantilever of the driving outrigger mechanism (601).

6. The wheeled material distributing machinery according to claim 5, wherein at least one of the axle assemblies is an axle assembly having an independent drive mechanism.

7. The wheeled material distributing machinery according to claim 5, wherein at least two driving outrigger mechanisms (601) are formed, the multiple axle assemblies are at least divided into a first axle assembly group and a second axle assembly group, the axle assembly of the first axle assembly group is mounted on the cantilever of a driving outrigger mechanism (601), and the axle assembly of the second axle assembly group is mounted on the cantilever of another driving outrigger mechanism (601).

8. The wheeled material distributing machinery according to claim 7, wherein extension directions of the driving outrigger mechanisms (601) remain parallel with each other.

9. The wheeled material distributing machinery according to claim 7, wherein an inner end of each of the outrigger mechanisms (600) is hinge-connected to the material distributing frame (400) through a vertical hinge-connecting shaft, and the axle assembly is connected to the cantilever of the driving outrigger mechanism (601) through a vertical hinge-connecting shaft.

10. The wheeled material distributing machinery according to claim 1, wherein the material distributing frame (400) comprises a slewing mechanism, the slewing mechanism comprises a rotary component (401) and a fixed component (402) that form a rotatable fit, the rotary component (401) is connected to the inner end of the root end boom (210), and the inner end of the outrigger mechanism (600) is connected to the fixed component (402).

11. The wheeled material distributing machinery according to claim 1, wherein the material distributing frame (400) is hinge-connected to the inner end of the root end boom (210) through a horizontal hinge-connecting shaft (211).

12. The wheeled material distributing machinery according to claim 1, wherein the material distributing frame (400) is fixedly connected to the inner end of the root end boom (210), and the driving outrigger mechanism is connected to the material distributing frame (400) through a horizontal hinge-connecting shaft.

13. The wheeled material distributing machinery according to claim 1, further comprising a pumping assembly connected to the material distributing frame (400), wherein the pumping assembly comprises a pumping system (320) and a pump auxiliary travel system (310) connected to the pumping system (320).

14. The wheeled material distributing machinery according to claim 13, wherein a pumping support (311) of the pump auxiliary travel system (310) is connected to the material distributing frame (400) through a middle hinge-connecting shaft (301), and the axis of the middle hinge-connecting shaft (301) is perpendicular to a horizontal plane.

15. The wheeled material distributing machinery according to claim 14, further comprising an outrigger mechanism (600) having an inner end hinge-connected to the pumping support (311) through an outrigger hinge-connecting shaft, wherein the axis of the outrigger hinge-connecting shaft is parallel with the axis of the middle hinge-connecting shaft (301).

16. The wheeled material distributing machinery according to claim 1, further comprising a frame auxiliary travel system (420), wherein an axle assembly of the frame auxiliary travel system (420) is mounted on the material distributing frame (400), and in the travel state, the axle assembly of the frame auxiliary travel system (420) is supported on the road surface.

17. The wheeled material distributing machinery according to claim 1, further comprising a turning drive mechanism connected to the boom system (200), wherein when the wheeled material distributing machinery switches from the travel state to a predetermined working state, the turning drive mechanism is supported on the ground, and drives the boom system (200) to turn.

18. The wheeled material distributing machinery according to claim 1, further comprising an operating cab (800) located on the outrigger mechanism (600) or a predetermined boom of the boom system (200), wherein the operating cab (800) comprises a travel control mechanism, and the travel control mechanism is capable of controlling operation of the main travel system (100).

19. The wheeled material distributing machinery according to claim 1, further comprising a state detection sensor and a controller, wherein the state detection sensor is used to detect a state of the root end boom (210), and the controller outputs a position signal according to a detection signal of the state detection sensor.

20. The wheeled material distributing machinery according to claim 19, wherein the state detection sensor is a tilt-angle sensor, the tilt-angle sensor detects a tilt angle of the root end boom (210), and the controller determines, according to a detection result of the tilt-angle sensor, whether state switching is completed, and when it is determined that the state switching is completed, outputs a predetermined position signal.
